(19) United States
(12) Patent Application Publication
(10) Pub. No.: US 2015/0177768 A1
(43) Pub. Date: Jun. 25, 2015

(54) PORTABLE GREEN POWER DEVICE

(71) Applicant: TAIGULF CO., LTD., New Taipei City (TW)

(72) Inventor: Che-Peng Liang, Kaohsiung City (TW)

(21) Appl. No.: 14/580,238

(22) Filed: Dec. 23, 2014

Related U.S. Application Data
(60) Provisional application No. 61/919,819, filed on Dec. 23, 2013.

(30) Foreign Application Priority Data
Mar. 3, 2014 (TW) 103107064
Mar. 3, 2014 (TW) 103203609

(51) Int. Cl. G05F 1/67; H02J 1/00; H02J 3/00; H02J 7/00

(52) U.S. Cl. CPC G05F 1/67; H02J 7/0042; H02J 7/0029; H02J 1/00; H02J 3/00; H02J 2007/004

(57) ABSTRACT

A portable green power device includes an energy storage module, a manpower generating module, a control unit and an AC charging module. The energy storage module has input terminals, output terminals and a DC charging port. The output terminal is connected to an additional energy storage module in parallel and/or an external device. The energy storage module is electrically connected in parallel to expand power storage capacity, and the expansion still enable charging and discharging synchronously with voltage levels balanced dynamically. The manpower generating module utilizes relative movement between a magnetic components and an induction coil to generate energy. The control unit tracks and collects the power generated by the manpower generating module with the maximum power point tracking circuit and then transfers the power to the energy storage module. The AC charging module transforms AC power to DC power and transfers the DC power to the energy storage module.

### CROSS REFERENCE TO RELATED APPLICATIONS

This application claims the benefit of U.S. provisional application No. 61/919,819, filed on Dec. 23, 2013. The entire contents of these related applications are incorporated herein by reference.

### BACKGROUND OF THE INVENTION

1. Field of the Invention

The present invention relates to a portable green power device with an expandable power storage capacity, and more particularly, to a portable green power device capable of collecting and storing energy generated by human power and further capable of storing energy from the city power, an external solar power generating device and/or an external wind power generating device and further increasing power storage capacity by an expansion of numerous energy storage modules electrically connected in parallel.

2. Description of the Prior Art

With the advanced technology, various electronic and electrical products are widely used in daily life, and the energy consumption grows accordingly. Most of the traditional power supplies are fossil fuel-based ones, which have drawbacks of expensive cost and the exhausting resources. On the contrary, green energy from solar and wind requires huge and very costly power generating equipment with geographical limits and is not as popular as expected to properly replace fossil fuel energy. In case of any natural or man-made disaster occurs, residents may lose power supply to drive household appliances while current power facilities are partially or completely shut down. The fossil fuel generator has been the most common emergent solution, but the fossil fuel may not be readily and constantly available. In contrast, a portable green power generator with functions of power storage and capacity expansion would be a convenient affordable and immediate solution in the environment-friendly industry.

### SUMMARY OF THE INVENTION

The present invention provides a portable green power device capable of collecting and storing energy generated by human power and further capable of storing energy from the city power, an external solar power generating device and/or an external wind power generating device. The power storage capacity can further increase by an expansion of numerous energy storage modules electrically connected in parallel for solving above drawbacks.

According to the claimed invention, the portable green power device, also named as a portable manpower generator with power storage and expansion, includes an energy storage module, a manpower generating module, a control unit, and an AC charging module.

The energy storage module contains one or multiple energy storage units. The energy storage module includes input terminals for receiving power from internal and external generating modules, output terminals for being connected to external devices that require power, and a DC charging port for receiving power from city power grid. The main board of the energy storage module includes a protection circuit and a parallel dynamic self-balancing management circuit. The energy storage modules can be electrically connected in parallel to multiply expand the power capacity. The paralleled energy storage modules can further expand the power capacity and sources by receiving power generated from external solar power generating modules and/or by external wind power generating modules, which are independently connected via separate control units.

The manpower generating module is electrically connected to the input terminals of the energy storage module. The manpower generating module generates energy and transfers the energy through the control unit into the energy storage module. The control unit is electrically connected to the manpower generating module. The control unit detects the characteristics of the power generated by the manpower generating module by means of MPPT technology, and finds out power points conforming to a preset threshold so as to transfer the related energy into the energy storage module. The control unit maybe designed to use other power collecting/charging methods, such as PWM or any others. Any method capable of collecting/charging power belongs to the scope of the present invention.

The AC charging module is electrically connected to the input terminals of the energy storage module. The AC charging module transforms AC power from city power into DC power and then transfers the energy into the energy storage module through the DC charging port on the device panel, and/or through the DC charging port on the energy storage module.

The present invention can effectively generate, collect and store energy. The portable green power device can be coupled with an adapter and/or an inverter, and furthermore be applied to go with additional energy storage modules of the same design electrically connected in parallel. With such a consolidation and solution, it conveniently provides sufficient energy in the regions where power facilities do not properly work.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a portable manpower generator with power storage and expansion according to an embodiment of the present invention.

FIG. 2 is a functional block diagram of the portable manpower generator with power storage and expansion according to the embodiment of the present invention.

FIG. 3 is a diagram illustrating an energy storage module according to the embodiment of the present invention.

FIG. 4 is a diagram illustrating the energy storage module with multiple positive/negative terminals according to another embodiment of the present invention.

FIG. 5 is a functional block diagram illustrating the energy storage module according to the embodiment of the present invention.

FIG. 6 is a diagram illustrating the energy storage modules electrically connected in parallel according to the embodiment of the present invention.

FIG. 7 is a diagram illustrating a manpower generating module according to the embodiment of the present invention.

### DETAILED DESCRIPTION

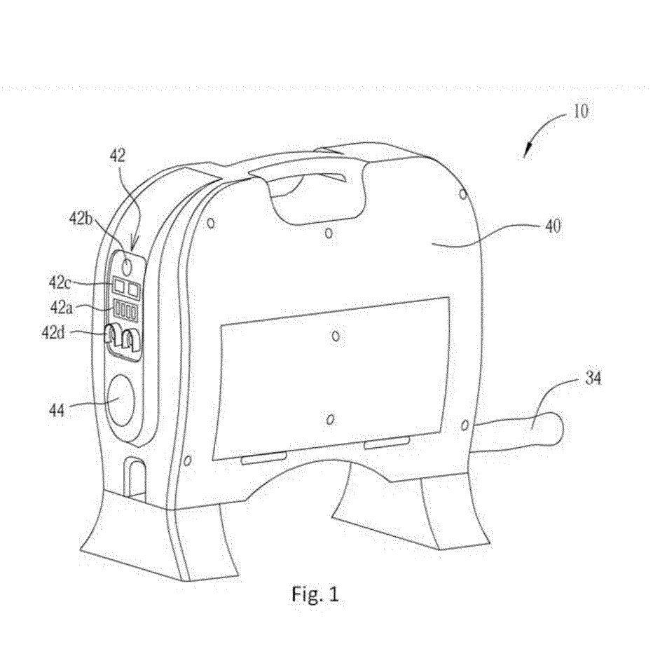

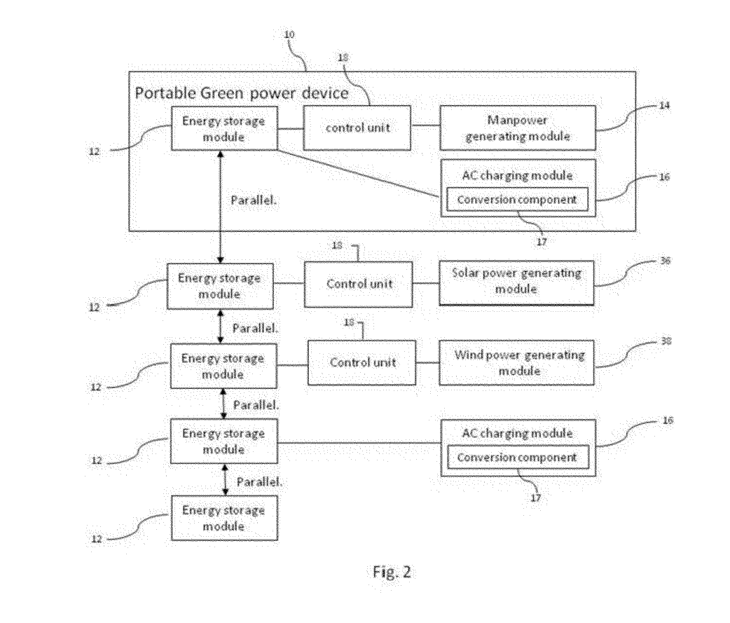

Please refer to FIG. 1, and FIG. 2. FIG. 1 is a diagram illustrating a portable green power device 10 according to an embodiment of the present invention. FIG. 2 is a functional block diagram of the portable green power device 10 according to the embodiment of the present invention. The portable green power device 10, also named as a portable manpower generator with power storage and expansion, includes an energy storage module 12, a manpower generating module 14, a control unit 18, and an AC (alternating current) charging module 16. The portable green power device 10 may optionally include an external solar power generating module 36 and/or a wind power generating module 38 which are electrically connected to other energy storage modules 12 by parallel connection via other control units 18. The energy storage module 12 is a combination of one or numerous energy storage units 20 electrically connected in parallel (for parallel connection) and/or in series (for series connection). When the energy storage module 12 is a combination of numerous energy storage modules, the energy storage modules 12 are electrically connected in parallel. The manpower generating module 14 is electrically connected to the energy storage module 12 via the control unit 18. Energy is generated by the manpower generating module 14 and can be transferred to the energy storage module 12 for storage. The manpower generating module 14 may include various types of manpower mechanism. The control unit 18 is electrically connected to the manpower generating module 14. The control unit 18 can adopt a maximum power point tracking (MPPT) circuit to detect characteristics of the energy generated by the manpower generating module 14, and collect the energy at the maximum power points to enhance charging efficiency of the energy storage module 12. The AC charging module 16 can be an adapter, and is electrically connected to the energy storage module 12 to transfer energy from the city power facility to the energy storage module 12 for storage. The portable green power device 10 can be used in places where the city power facility is established to receive electricity by the AC charging module 16, as well as being used by operating the manpower generating module 14 in the regions where usual power facilities are not available. Therefore, the portable green power device 10 of the present invention allows users to obtain sufficient energy in any environment.

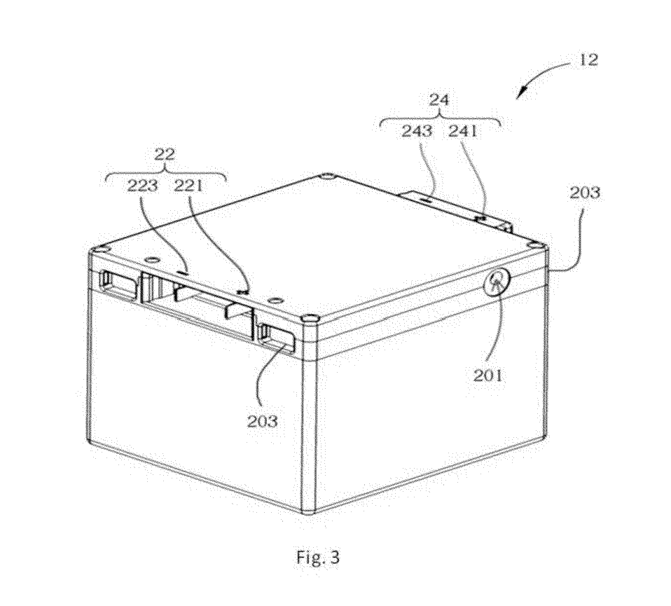

FIG. 3 is a diagram illustrating the energy storage module 12 according to the embodiment of the present invention. The energy storage module 12 has input terminals 22 and output terminals 24, which are placed on opposite sides of the energy storage module 12. The input terminals 22 include an input positive terminal 221 and an input negative terminal 223. The output terminals 24 include an output positive terminal 241 and an output negative terminal 243. The input terminals 22 are electrically connected to the manpower generating module 14 via the control unit 18 or connected to the AC charging module 16. The output terminals 24 are utilized to connect to another paralleled energy storage module or any external device that requires energy to operate. Due to the input and output terminals, the energy storage module 12 can output the energy to other paralleled energy storage modules 12 or to any external device that requires the energy with their voltages dynamically balanced, and further meantime can receive the energy independently from the manpower generating module 14 and/or from the AC charging module 16 simultaneously. It is to say, the energy storage modules 12 electrically connected in parallel still provide functions of charging and discharging synchronously and simultaneously at a dynamic balancing voltage level. The performance of the energy storage modules 12 is thereby maintained and service life is accordingly secured and extended. The energy storage unit 20 preferably can be the polymer lithium battery. The energy storage module 12 can be a combination of three energy storage units 20 electrically connected in series, or a combination of three energy storage units 20 electrically connected in series and four foresaid combinations electrically connected in parallel. Each energy storage module 12 can be electrically connected to other one or more energy storage modules in series connection or in parallel connection. The combination is adaptable and unlimited based on various needs and designs. The energy storage module 12 may include a DC (direct current) charging port 201 to independently receive the energy from the city power facility via an adapter, and can be adapted to electrically connect with other energy storage modules 12 in parallel connection via the integration joins 203.

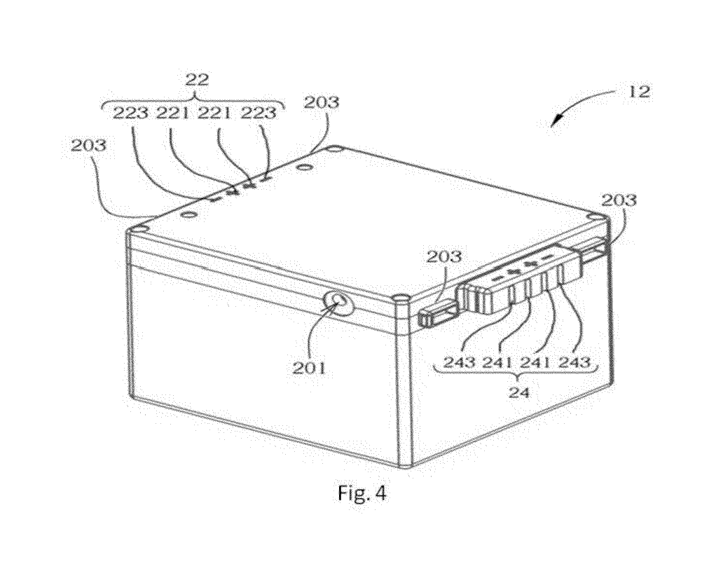

FIG. 4 is a diagram illustrating the energy storage module 12 with multiple positive/negative terminals according to another embodiment of the present invention. The energy storage module 12 of this embodiment includes a set of input terminals 22 and a set of output terminals 24 respectively placed at the opposite sides of the energy storage module 12. The set of input terminals 22 is divided into two input positive terminals 221 and two input negative terminals 223, and the set of output terminals 24 is divided into two output positive terminals 241 and two output negative terminals 243. Comparing with FIG. 3, the set of input terminals 22 and the set of output terminals 24 of this embodiment respectively include plural positive terminals and plural negative terminals, which are utilized to intentionally control temperature increase and can supply power to other paralleled energy storage modules and/or external devices that require the energy to operate. Owing to the input and output terminal sets of the energy storage module 12, the energy storage module 12 can output the energy to other paralleled energy storage modules 12 and/or to external device that require the energy with their voltages dynamically balanced, and simultaneously receive power independently from the manpower generating module 14 and/or from the AC charging module 16. Therefore, the energy storage modules 12 can still provide functions of charging and discharging synchronously and simultaneously even when they are electrically connected in parallel, and further have its efficiency and the service life protected in the meantime. The energy storage module 12 further may include a DC charging port 201 to independently receive the energy from the city power facility via an adapter, and can be adapted to electrically connect with other energy storage modules 12 in parallel connection via the integration joins 203. In addition, appearance of the energy storage module 12 is not limited to the embodiments shown in FIG. 3 and FIG. 4. The energy storage module 12 with the set of the input terminals 22 and the set of the output terminals 24 having one or more terminals belongs to the scope of the present invention.

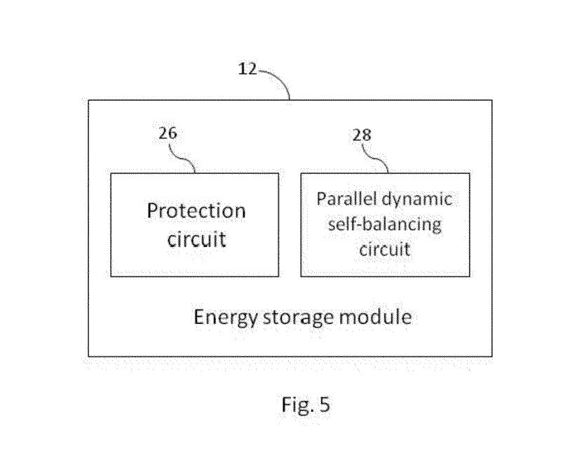

Please refer to FIG. 3 to FIG. 6. FIG. 5 is a functional block diagram illustrating the energy storage module 12 according to the embodiment of the present invention. The energy storage module 12 includes a protection circuit 26 and a parallel dynamic self-balancing circuit 28. The protection circuit 26 provides proper functions of over-charging protection, over-discharging protection, over-heat protection, over-current protection, and short-circuit protection, which depends on actual situations. In this implementation, the protection circuit 26 may better be,
(1) set for each energy storing unit 20 that stops discharging at 3.4 volts or lowest at 3.0 volts, and
(2) set to control the maximum discharge capacity of each energy storage module 12 during each discharge time is not greater than 2 C of the rated power capacity, and
(3) set to control the maximum discharge capacity of each energy storage module 12 during each discharge time does not exceed eighty-five prevent of the rated power capacity.
   This is to ensure the safety of the energy storage module 12 and to prolong the related service life.

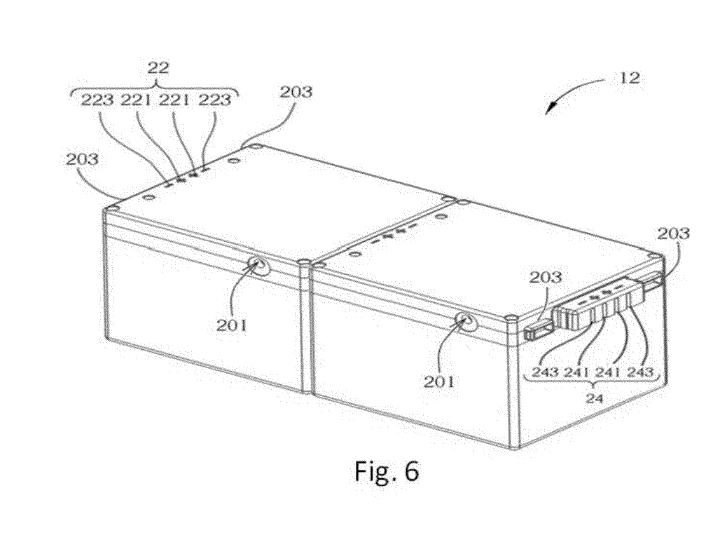

FIG. 6 is a diagram illustrating the energy storage modules 12 electrically connected in parallel according to the embodiment of the present invention. The parallel dynamic self-balancing management circuit 28 drives the output voltage and the input voltage of any energy storage modules 12 electrically connected in parallel to actively flow dynamically inside the parallel till voltages are balanced and stable. According to the parallel dynamic self-balancing management circuit 28, a plurality of energy storage modules 12 can be electrically connected in parallel connection to expand the power capacity simultaneously. That is, the parallel dynamic self-balancing management circuit 28 allows the output/input voltage levels of each energy storage module 12 dynamically flowing among all energy storage modules 12 while the energy storage modules 12 are electrically connected in parallel, till the voltage levels of the paralleled energy storage modules 12 are stable and balanced. An additional newly joined energy storage module 12 to parallel with other paralleled energy storage modules 12 which have already obtained balanced input/output voltage levels will immediately cause all the voltages of this new parallel combination (including the newly joined energy storage module 12 and the original paralleled energy storage modules 12 in parallel connection) to actively flow again in between till all together they achieve a new balance within a certain period of time. Therefore, the energy storage modules 12 electrically connected in parallel can stably charge and discharge at a stable voltage level in synchrony to keep the efficiency and the service life of the energy storage modules 12. Amounts of the energy storage modules 12 electrically connected in parallel are not limited to the above-mentioned embodiment, and depend on actual demand.

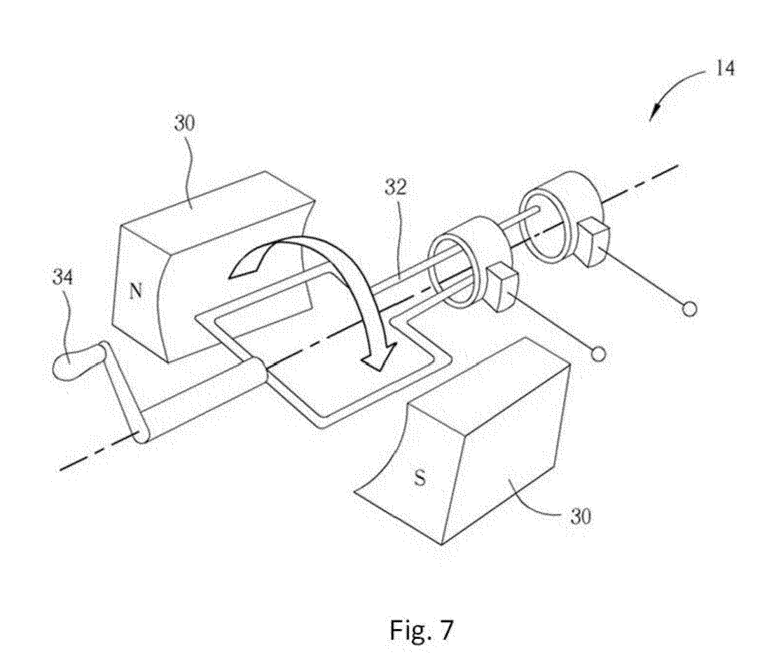

Please refer to FIG. 7. FIG. 7 is a diagram illustrating the manpower generating module 14 according to the embodiment of the present invention. The manpower generating module 14 includes magnetic components 30 and the induction coil 32. The induction coil 32 is movably disposed on the magnetic components 30. The induction coil 32 is connected to the handle 34, as shown in FIG. 1. The user operates the handle 34 to move the induction coil 32 relative to the magnetic components 30, and the energy is generated by the induction coil 32 according to electromagnetic induction. The manpower generating module 14 transfers the energy to the energy storage module 12 for storage, and/or to be used by the external devices that require the energy. It should be mentioned that the induction coil 32 of this embodiment of the present invention is rotated relative to the magnetic components 30. In other embodiment, the inductive coil 32 may move relative to the magnetic components 30 linearly, which depends on design of the manpower generating module 14. Mechanism of the manpower generating module 14 is thereof not limited to the foregoing embodiment, and a detailed description is omitted herein for simplicity.

The control unit 18 can be a maximum power point tracking (MPPT) circuit for collecting the energy by detecting the characteristics of the energy generated by the manpower generating module 14. The theory is, for example, to calculate the energy with a multiple calculator and combine the voltage value and the current value to obtain the energy value of the main circuit DC voltage and output current. To measure the current by comparing the output power changed from the disturbance resistance of the manpower generating module 14 through a comparator in order to track the maximum power point. The power collecting technology of the manpower generating module 14 is thereof not limited to the foregoing embodiment, and is not to be indicated one by one. The energy generated by the manpower generating module 14 may have an off-cyclical change with operator's strength intensity, which corresponds to the rotational speed of the induction coil 32. The control unit 18 can immediately detect the current generated by the manpower generation module 14, and compare the foresaid current with the previous power or the memorized value. By adjusting the duty cycle of MOSFETs (Metal-Oxide-Semiconductor Field-Effect Transistor, MOSFET) to change the average current that goes through the disturbance resistance, it will result in the changes of the output current/voltage, and the maximum power point can be thus found. That means to find out power points conforming to (for example, greater than) a preset threshold which may depend on types and environments of the power generating modules. As a result, the control unit 18 can remain the manpower generating module 14 to work at the maximum power point all the times and to get the energy storage module 12 charged fast for full power. MOSFETs can be replaced by diodes, or any other electronic components, which depend on the needs of the designs. The portable green power device 10 is not limited to a foresaid combination of the manpower generation module 14 and the control unit 18 (the MPPT circuit), and any other power collecting/storing technology applied to the manpower generation module 14 is allowed for consideration.

Please refer again to FIG. 2. The AC charging module 16 includes a conversion component 17, which is an AC-DC adapter. The AC charging module 16 receives AC power from the city power facility and transforms the AC power into DC power in order to store the DC power into the energy storage module 12. The AC charging module 16 of the embodiment of this present invention converts electricity of regular 100/250 volt AC power to the DC power and transfers the DC power to the energy storage module 12.

To charge from more sources, the portable green power device 10 may further include a solar power generating module 36 and a wind power generating module 38, which can be electrically connected to the storage modules 12 via their control units 18. The solar power generating module 36 and the wind power module 38 are optionally selected, and each of the solar power generating module 36 and/or the wind power module 38 may use the maximum power point tracking (MPPT) circuit to charge the energy storage module 12. The solar power generating module 36 and the wind power module 38 may independently operate or work together with the manpower generating module 14 to generate clean energy. Since the generating efficiency of the solar power generating module 36 may have off-cyclical changes depending on strength of the sunshine, and the power generated by the wind power generating module 38 may also have an off-periodic change due to intensity of the wind-blow, the related control units 18 may detect the characteristics of the power generated, track the maximum power point, and control the solar power generating module 36 and the wind power generating module 38 to work at the maximum power point at all times. As further embodiments, portable and foldable solar panels are preferable for the solar power generating module 36, while the small efficient wind turbine is preferable for the wind power generating module 38. They should not be limited thereof.

Please refer to FIG. 1. The portable green power device 10 may further include a case 40, a control panel 42 and a lighting unit 44. The energy storage module 12, the manpower generating module 14 and the control unit 18 are disposed in the case 40. The control panel 42 is placed on an outer surface of the case 40. The control panel 42 may have one or more DC paralleling battery interfaces 42a, which are electrically connected to the input terminals 22 of the energy storage module 12. The DC paralleling battery interfaces 42a are to be connected to external energy storage modules 12, in order to receive power from the solar power generating module 36 and/or the wind power generating module 38, through the related control units that may use the maximum power point tracking (MPPT) circuit. The control panel 42 may also have a DC charging port 42b electrically connected to the AC charging module 16. The control panel 42 may also have one or more DC low voltage ports 42c, and one or more inverter ports 42d, which are electrically connected to the output terminals 24 of the energy storage module 12. The DC low voltage port 42c may be the interface of the Universal Serial Bus (USB), commonly used as a charging port for portable electronic products, or a power supply for low voltage DC. The inverter port 42d is configured for an inverter (not shown in the figures), which is utilized to transform the DC power from the energy storage module 12 into the AC power for external household appliances which require the energy from 100 watts to 500 watts or more depending on the specifications of inverters, but should not exceed 950 watts at all times for safety. However, each interface type and related parameters of the control panel 42 on configuration is not limited thereto. The lighting unit 44 preferably can be the LED with high photoelectric color quality characteristics, such as low power consumption, high color rendering index, and no flicker. The lighting unit 44 is electrically connected to the output terminals of the energy storage module 12, and can provide sufficient outdoor illumination by low consumption of the DC power.

In conclusion, the present invention utilizes portable types of the manpower generating module, the solar power generating module, and/or the wind power generating module to drive the portable green power device to independently generate power in the regions where the power supply facilities are in absence or not working well. With the function of the maximum power point tracking (MPPT) technology, the control units particularly for manpower generating module effectively enhance the charging performance of the energy storage modules. In addition to the regular protection circuit for battery, this present invention adapts a design with plural terminals for thermal control, and further adapts a design with the parallel dynamic self-balancing management circuit to allow the various voltages of the paralleled energy storage modules to actively flow so the voltages will reach a balanced level in a limited period of time and stay stable. With such a dynamic voltage self-balancing management for parallel, the power capacity can be expanded by having numerous energy storage modules in parallel and that expansion also performs charging and discharging synchronously without damaging the efficiency and the service life of the batteries. The input and output terminals of the energy storage module allows to receive power from energy generating modules, and in the meantime to output power to external devices that require power to operate. In regions where the city power facilities are established, the energy storage module can be conveniently charged through the AC charging module. Comparing to the prior art, the present invention can effectively generate, collect and store green energy, and enable green energy transportable and power storage flexibly expandable. With design of the adapter and the inverter capable of exchanging the AC power and the DC power therebetween, and preferably in a portable type, the present invention conveniently provides users adequate energy supply in any region where power facilities are in absence or not working properly.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A portable green power device, comprising:
an energy storage module having input terminals, output terminals and a DC charging port, the input terminals and the output terminals being a plurality of positive terminals and a plurality of negative terminals, the output terminals being adapted to connect to at least one additional energy storage module electrically connected in parallel and/or external devices, a main board of the energy storage module comprising a protection circuit and a parallel dynamic self-balancing management circuit, the energy storage module being adapted to electrically connect in parallel to expand power storage capacity, so as synchronously to charge and discharge with voltage levels balanced dynamically;
a manpower generating module electrically connected to the input terminals of the energy storage module, the manpower generating module comprising magnetic components and an induction coil, and the induction coil being movably disposed on the said magnetic components, the manpower generating module utilizing a relative movement between the magnetic components and the induction coil to generate energy;
a control unit electrically connected to the manpower generating module and the input terminals of the energy storage module, the control unit tracking and collecting the energy generated by the manpower generating module with a maximum power point tracking (MPPT) circuit and transferring the energy to the energy storage module; and
an AC charging module electrically connected to the input terminals of the energy storage module, the AC charging module being adapted to transform AC power to DC power and then to transfer the DC power to the energy storage module.

2. The portable green power device of claim 1, wherein the AC charging module comprises a conversion component adapted to convert the AC power to the DC power.

3. The portable green power device of claim 1, wherein the portable green power device comprises at least one DC paralleling battery interface electrically connected to the input terminals of the energy storage module, the portable green power device further comprises at least one DC low voltage port electrically connected to the output terminals of the energy storage module.

4. The portable green power device of claim 1, wherein the input terminals comprise at least one input positive terminal and at least one input negative terminal, and the output terminals comprise at least one output positive terminal and at least one output negative terminal.

5. The portable green power device of claim 1, wherein the control unit receives the energy generated from the manpower generating module, and simultaneously transfers the energy to the energy storage modules electrically connected in parallel, or to an external device requiring the energy, or to an additional external plural energy storage modules electrically connected in parallel through a specified connector.

6. The portable green power device of claim 1, wherein the energy storage module utilizes the protection circuit to control and limit discharge voltage of the energy storage module within a certain range, and the maximum discharge capacity not exceeding 2 C of rated power capacity during a discharge time, or no more than 85% of total capacity in order to protect the energy storage module for extended life.

7. The portable green power device of claim 1, wherein the energy storage module utilizes the parallel dynamic self-balancing management circuit to drive the input voltages and the output voltages among a plurality of energy storage modules electrically connected in parallel to actively flow in a limited time till the input voltages and the output voltages are balanced at a stable level.

8. The portable green power device of claim 1, wherein the MPPT circuit of the control unit tracks to find the maximum power point conforming to a preset threshold, and drives the manpower generating module to transfer the maximum power point to the energy storage module.

9. The portable green power device of claim 1, further comprising:
a solar power generating module electrically connected to the energy storage module via the control unit, the control unit driving the solar power generating module to transfer the energy to the energy storage module.

10. The portable green power device of claim 1, further comprising:
a wind power generating module electrically connected to the energy storage module via the control unit, the control unit driving the wind power generating module to transfer the energy to the energy storage module.

11. The portable green power device of claim 1, further comprising:
a lighting unit electrically connected to at least one of the output terminals of the energy storage module.
